(19) United States
(12) Patent Application Publication
(10) Pub. No.: US 2015/0280370 A1
(43) Pub. Date: Oct. 1, 2015

(54) RF Switch Connector

(71) Applicant: Insert Enterprise Co., Ltd., New Taipei City (TW)

(72) Inventors: Tung-Liang Huang, New Taipei City (TW); Sung-Wen Chen, New Taipei City (TW)

(21) Appl. No.: 14/299,762

(22) Filed: Jun. 9, 2014

(30) Foreign Application Priority Data
Mar. 31, 2014 (TW) 103205470

(51) Int. Cl. H01R 13/703

(52) U.S. Cl. CPC H01R 13/7036

(57) ABSTRACT

A RF switch connector includes: a housing; and a switch unit mounted in the housing. The switch unit includes a fixed terminal having a first contactor formed on the fixed terminal, and a switchable terminal having a second contactor formed on a switch lever cantileverably linked to the switchable terminal and resiliently urged by a spring retained in the housing to allow the second contactor to be normally contacted with the first contactor to form a closed circuit between the fixed terminal and the switchable terminal, and having a third contactor protruding upwardly from the switch lever. Upon an insertion of a plug of a mating connector into said housing to downwardly depress the third contactor, the third contactor will be contacted with the plug to externally connect an external signal source through the mating connector.

### RELATED APPLICATION

This application claims the benefit of Taiwanese patent application 103205470, filed on Mar. 31, 2014, the specification of which is incorporated here by this reference.

### BACKGROUND OF THE INVENTION

A conventional radio frequency (RF) switch connector may be provided to connect a portable electronic device (such as: a portable notebook computer, a flat computer or a cell phone) and an externally connected antenna or signal source in order to efficiently receive radio frequency signals for data communication or treatment.

Such a conventional RF switch connector may include a fixed terminal normally resiliently contacted with a movable (or switch) terminal within a housing; and upon insertion of a mating connector, one end of the movable terminal will be disconnected from the fixed terminal under a press force, and the movable terminal will be outwardly connected with the mating connector for connecting an external signal source.

For doing so, a RF switch connector of U.S. Patent Pub. No. 2006/0128195 disclosed a switch terminal (3) having a contact portion (30) normally electrically connected with another contact portion (20) of a fixed terminal (2) by a spring function existing in the switch terminal (3) itself. When a contact (5) of a mating connector is inserted into the switch connector, the switch terminal (3) will be disconnected from the fixed terminal (2).

However, such a conventional RF switch connector may have the following disadvantages:
1. Since there is no buffer or cushioning means provided under the contact portion (30) of the switch terminal (3), the repeated connections or disconnections of the switch terminal (3) and the fixed terminal (2) may cause fatigue failure (or even permanent deformation) of the springy contact portion (30) of the switch terminal (3) to loosen the close connection between the two terminals (3, 2), thereby deteriorating the signal transmission therebetween.
2. Once removing the mating connector, it may take a longer time to restore the connection of the switch terminal (3) with the fixed terminal (2) due to the fatigue failure of the springy contact portion (30) of the switch terminal (3), thereby influencing the signal communication for the two closed terminals (3, 2).
3. Even a shielding member (4) is provided for shielding purpose, it is still not enough for completely shielding the lower portion of the connector because the shielding member (4) is not downwardly extended to well encase the two terminals (3, 2), thereby still causing noise interference occurring during the signal transmission as the poor shielding.

The present inventor has found the drawbacks of the conventional RF switch connector, and invented the present RF switch connector with more reliable signal connection and transmission.

### SUMMARY OF THE INVENTION

The object of the present invention is to provide a RF switch connector including: a housing; and a switch unit mounted in the housing, and the switch unit including a fixed terminal having a first contactor formed on the fixed terminal, and a switchable terminal having a second contactor formed on a switch lever cantileverably linked to the switchable terminal and resiliently urged by a spring retained in the housing to allow the second contactor to be normally contacted with the first contactor to form a closed circuit between the fixed terminal and the switchable terminal, and having a third contactor protruding outwardly or upwardly from the switch lever; whereby upon an insertion of a plug of a mating connector into said housing to downwardly depress the third contactor by a plug pin of the mating connector, the second contactor will be disconnected from the first contactor, and the third contactor of the switchable terminal of the switch unit will be contacted with the plug pin to externally connect an external signal source through the mating connector.

### BRIEF DESCRIPTION OF THE DRAWINGS

FIG. 1 is an exploded view of the present invention.

FIG. 2 is a perspective view of the present invention when assembled.

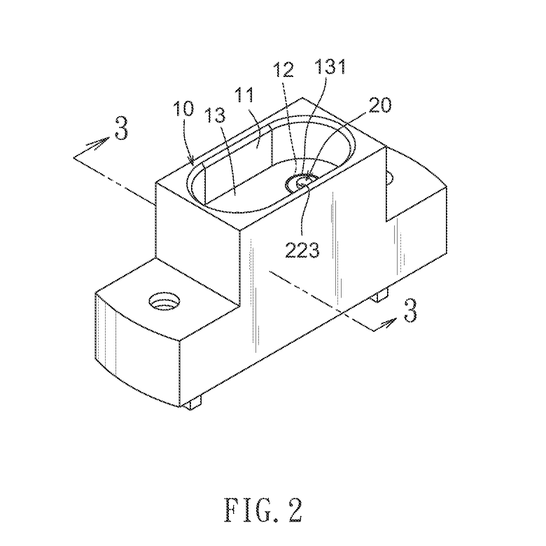

FIG. 3 is a partial sectional drawing of the present invention when viewed from Line 3-3 of FIG. 2.

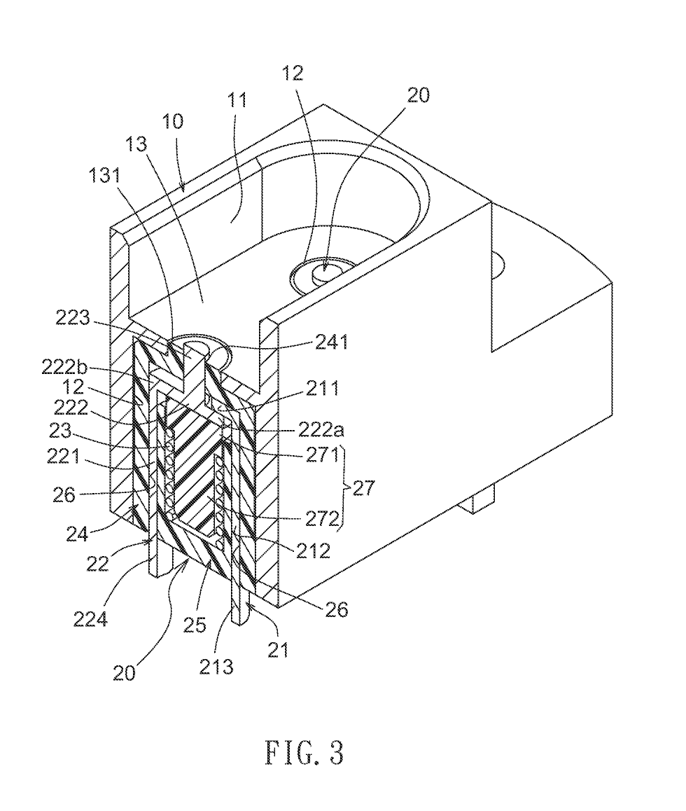

FIG. 4 is a sectional drawing of the present invention.

FIG. 5 is a sectional drawing when inserting a mating connector into the switch connector of the present invention.

### DETAILED DESCRIPTION

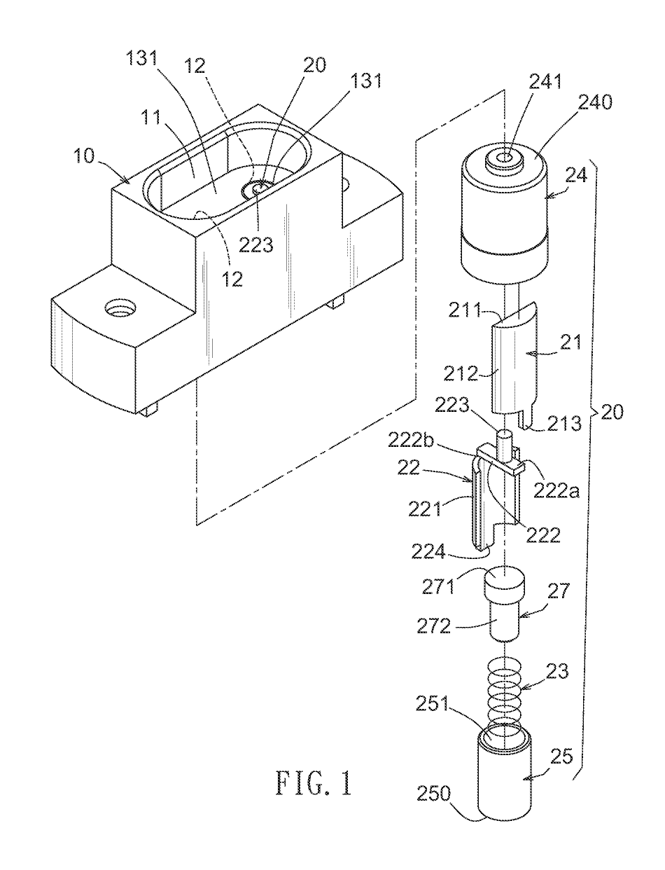

As shown in FIGS. 1˜5, a RF switch connector of the present invention comprises: a housing 10; and at least a switch unit 20 mounted, encased or embedded in the housing 10.

The housing 10 includes a receptacle 11 recessed in an upper portion of the housing for engaging a plug 30 of a mating connector in the receptacle 11, at least a switch cavity 12 recessed in a lower portion of the housing for mounting the switch unit 20 in the switch cavity 12, and a partition plate 13 defined between the receptacle 11 and the switch cavity 12 for downwardly resting the plug 30 of the mating connector on the partition plate 13 and for upwardly limiting the switch unit 20 against the partition plate 13, having at least a terminal hole 131 formed through the partition plate 13 for protruding part of the switch unit 20 upwardly (or outwardly) to be contacted with the plug 30 of the mating connector.

The housing 10 is made of electrically conductive materials, such as copper or electrically conductive plastic, and mounted on a circuit board P to be electrically connected with a grounding loop, path or circuit of the circuit board P.

The switch unit 20 includes: a fixed terminal 21; a switchable terminal 22 juxtapositioned to the fixed terminal 21; a spring 23; an outer cup 24 encasing the fixed terminal 21 and the switchable terminal 22 in the outer cup 24; an inner cup 25 cylindrically disposed within the outer cup 24 having an annular slot 26 defined between the outer and inner cups 24, 25; with the fixed terminal 21 and the switchable terminal 22 juxtapositionally received in the annular slot 26; and a pusher member 27 slidably held in the inner cup 25 and resiliently retained on the spring 23 to normally urge the switchable terminal 22 upwardly (or outwardly) to be contacted with the fixed terminal 21 to form a closed circuit which may be defined as a “first closed circuit” originally laid out in a circuit board P, upon which the RF switch connector of the present invention is mounted, for transmitting signal internally in the closed circuit.

The fixed terminal 21 includes: a first contactor 211 formed on an upper (or outer) end of a fixed plate member 212, and a first bottom pin 213 formed on a bottom of the fixed plate member 212 and downwardly inserted into the circuit board P to be soldered on a circuit on the board P.

The switchable terminal 22 includes: a switch lever 222 cantileverably formed on an upper (or outer) portion of a movable plate member 221, a second contactor 222a formed on a free end of the switch lever 222 to be normally contacted with the first contactor 211 of the fixed terminal 21, a third contactor 223 formed on a central portion of the switch lever 222 and protruding upwardly or outwardly to be operatively contacted with a plug pin 31 of a plug 30 of a mating connector when inserted into the receptacle 11 of the housing 10, and a second bottom pin 224 formed on a bottom of the movable plate member 221 and downwardly inserted into the circuit board P to be soldered on the circuit of the board P.

Either plate member 212 or 221 is preferably made as an arcuate or partial cylindrical shape, but not limited in this invention.

The spring 23 is a helical spring or any other suitable springs held in the inner cup 25.

The outer cup 24 is formed as a cylindrical or cup shape with an open bottom and made of electrically insulative material. The outer cup 24 includes a sleeve portion 241 protruding upwardly or outwardly from a cover portion 240 formed on an upper portion of the outer cup 24, with the cover portion 240 limiting the first contactor 211 of the fixed terminal 21 thereunder.

The outer cup 24 is retained in the switch cavity 12 of the housing 10 to encase the fixed terminal 21 and the switchable terminal 22 in the outer cup 24; with the sleeve portion 241 engaged with a sleeve hole 131 formed in the partition plate 13 for protruding the third contactor 223 of the switchable terminal 22 upwardly through the sleeve portion 241 to be operatively contacted with the plug 30 of a mating connector.

The inner cup 25 is made of electrically insulative materials and formed as a cylindrical or cup shape having a closed bottom 250 for retaining a lower portion of the spring 23 thereon, and an opening 251 formed on a top of the inner cup 25 for an upward protruding of the pusher member 27 as resiliently urged by the spring 23.

The pusher member 27 includes a plunger 271 resiliently retained on an upper portion of the spring 23 to normally urge the switch lever 222 upwardly, and a rod portion 272 axially formed under the plunger 271 and disposed within the spring 23 to be reciprocatively moved within the inner cup 25.

The fixed terminal 21 and the switchable terminal 22 are each made of electrically conductive materials, such as copper. Each terminal may be integrally made by mechanical processing, such as cutting, milling or machining to enhance its mechanical strength. The shapes of each plate member 212, 221 may be cylindrical or arcuate or any other shape, not limited in this invention.

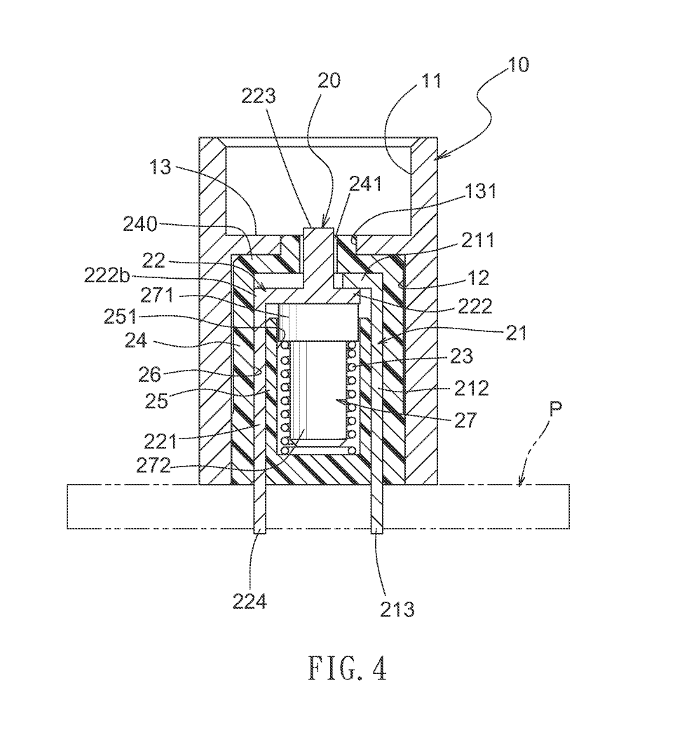

As shown in FIG. 4, the second contactor 222a formed on the switch lever 222 of the switchable terminal 22 is urged upwardly by the plunger 271 and spring 23 to contact the first contactor 211 of the fixed terminal 21 to close a circuit (which may be explained as a “first closed circuit”) as originally laid out in the circuit board P for an “internal” signal transmission. The contacting between the first and second contactors 211 and 222a will be very stable and reliable since the spring 23 resiliently urges the plunger 271 and the switch lever 222 upwardly to keep a well contacting between the two contactors 222a, 211 normally, thereby ensuring a reliable signal transmission between the two terminals 22, 21.

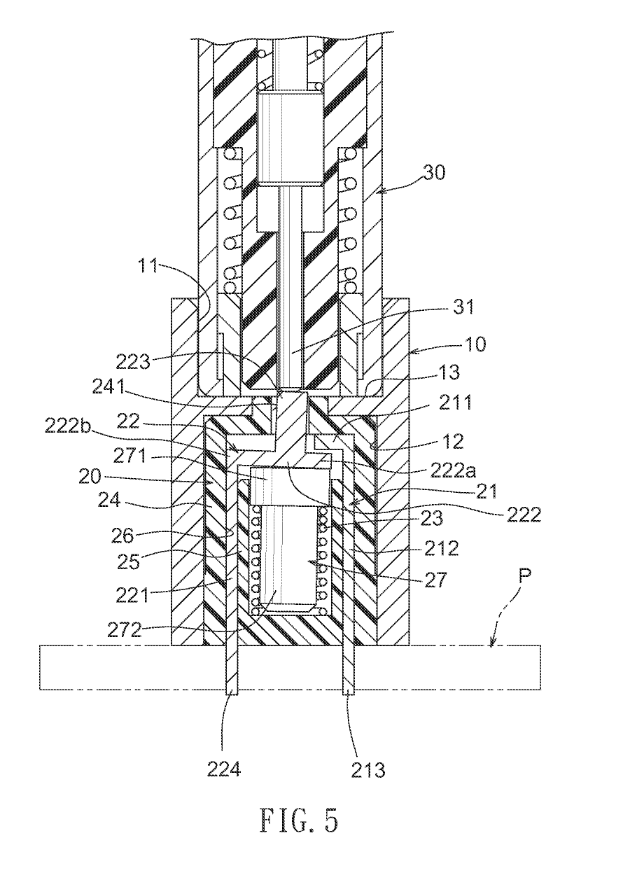

Upon an insertion of a plug 30 of a mating connector, as shown in FIG. 5, into the receptacle 11 of the housing 10, the plug pin 31 of the plug 30 will depress the third contactor 223 on the switch lever 222 downwardly to bias the second contactor 222a to be separated from the first contactor 211 to disconnect the “first closed circuit” (namely, the original internal closed circuit on the circuit board P).

Simultaneously, the downwardly depressed plug pin 31 is contacted with the third contactor 223 formed on the switch lever 222 so as to electrically connect the switchable terminal 22 of the RF switch connector of the present invention with the plug 30 of the mating connector, thereby forming a “second closed circuit”, namely, an “external” circuit, for connecting an external signal source (for instance, an external antenna or another electronic device).

The contacting between the third contactor 223 and the plug pin 31 will be ensured as urged by the spring 23, thereby enhancing a reliable signal transmission through the mating connector.

When downwardly depressing the plug 30 of the mating connector, a downward pressing force is acting upon the third contactor 223, the switch lever 222, and the plunger 271, bearing a spring force as urged by the spring 23. Therefore, the downward pressing force, when inserting the mating connector into the RF switch connector of the present invention, will be partially buffered by the spring 23. Only a partial pressing force, as acting upon the lever 222, will be transferred to the “fulcrum portion” 222b at a “linking junction” between the lever 222 and the movable plate member 221, so that the lever 222 will not be seriously “loaded”, thereby preventing a fatigue failure, permanent deformation or even breaking of the lever 222 from the terminal 22 and thereby prolonging the service life of the switch connector of the present invention.

Furthermore, when the mating connector is removed from the RF switch connector of the present invention, the plug pin 31 is removed and the third contactor 223 will no longer be downwardly depressed, and the spring 23 will restore to urge the plunger 271 and the switch lever 222 upwardly to further contact the second contactor 222a with the first contactor 211 to “recover” the “first closed circuit” as above-mentioned. Since the spring 23 help restore the re-closing of the two contactors 222a, 211, the original circuit can be immediately closed, thereby minimizing the signal disconnection interval when changing circuit of signal transmission.

The housing is made of electrically conductive materials, so that the noise occurring during the signal transmission may be eliminated as electrically connected with a grounding path or circuit in the circuit board P.

The present invention is superior to the prior arts with the following advantages:
1. The two contactors 222a, 211 (or the contactor 223 with the plug pin 31) will be closely contacted as urged by the spring 23 to thereby enhance a reliable signal transmission therebetween.
2. A downward depression force acting upon the switch lever 222, when connecting a mating connector with the RF switch connector, will be buffered by the spring 23, thereby preventing deformation of the lever and prolonging the life of the switch connector.
3. All elements of the present invention are well encased in the housing 10, thereby minimizing any noise interference or pollution and thereby enhancing a reliable signal communication quality.
4. The resilience of the lever 222 is compensated or assisted by the spring 23. Therefore, it is not so critical or necessary to select a lever having very high resilience which will be relatively expensive. So, the material cost of the present invention may be decreased, beneficial for its commercial use.
5. When removing the mating connector from the switch connector (from FIG. 5 to FIG. 4), the spring 23 will instantly urge the second contactor 222a to re-contact the first contactor 211 to quickly recover the original “internal closed circuit”, thereby shortening the time lag and minimizing the signal disconnection when changing a circuit.

The present invention may be further modified without departing from the spirit and scope of the present invention.

1. A Radio Frequency (RF) switch connector comprising: a housing mounted on a circuit board; and at least a switch unit mounted in the housing;
said switch unit including: a fixed terminal; a switchable terminal juxtapositioned to said fixed terminal; an outer cup encasing said fixed terminal and said switchable terminal in the outer cup; an inner cup cylindrically disposed within the outer cup for retaining a spring in said inner cup and having an annular slot defined between the outer and inner cups; with said fixed terminal and said switchable terminal juxtapositionally received in the annular slot; and a pusher member slidably held in the inner cup and resiliently retained on the spring to normally urge said switchable terminal to be contacted with said fixed terminal to normally form a closed circuit on the circuit board; whereby upon an insertion of a plug of a mating connector into said housing to downwardly depress said switchable terminal, said switchable terminal will be operatively disconnected from said fixed terminal and said switchable terminal will be operatively contacted with the plug to externally connect an external signal source through the mating connector.

2. A RF switch connector according to claim 1, wherein said housing includes a receptacle recessed in an upper portion of the housing for engaging the plug of the mating connector in the receptacle, at least a switch cavity recessed in a lower portion of the housing for mounting the switch unit in the switch cavity, and a partition plate defined between the receptacle and the switch cavity for downwardly resting the plug of the mating connector on the partition plate and for upwardly limiting the switch unit against the partition plate, having at least a terminal hole formed through the partition plate for protruding part of the switch unit upwardly to be contacted with the plug of the mating connector.

3. A RF switch connector according to claim 1, wherein said housing is made of electrically conductive materials, and mounted on the circuit board to be electrically connected with a grounding circuit of the circuit board.

4. A RF switch connector according to claim 1, wherein said fixed terminal includes: a first contactor formed on an upper end of a fixed plate member, and a first bottom pin formed on a bottom of the fixed plate member and downwardly inserted into the circuit board and soldered on the circuit on the circuit board.

5. A RF switch connector according to claim 1, wherein said switchable terminal includes: a switch lever cantileverably formed on an upper portion of a movable plate member, a second contactor formed on a free end of the switch lever to be normally contacted with the first contactor of the fixed terminal, a third contactor formed on a central portion of the switch lever and protruding upwardly through said outer cup to be contacted with a plug pin of the plug of the mating connector when inserted into a receptacle of the housing, and a second bottom pin formed on a bottom of the movable plate member and downwardly inserted into the circuit board to be soldered on the circuit of the circuit board.

6. A RF switch connector according to claim 1, wherein said spring is a helical spring.

7. A RF switch connector according to claim 1, wherein said outer cup is formed as a cylindrical or cup shape with an open bottom and made of electrically insulative material, and includes a sleeve portion protruding upwardly from a cover portion formed on an upper portion of the outer cup, with the cover portion limiting a first contactor of the fixed terminal thereunder; said outer cup retained in the switch cavity of the housing to encase the fixed terminal and the switchable terminal in the outer cup; with the sleeve portion engaged with a sleeve hole formed in the partition plate for protruding a third contactor of the switchable terminal upwardly through the sleeve portion to be operatively contacted with the plug of the mating connector.

8. A RF switch connector according to claim 1, wherein said inner cup is made of electrically insulative materials and formed as a cylindrical or cup shape having a closed bottom for retaining a lower portion of the spring thereon, and an opening formed on a top of the inner cup for an upward protruding of the pusher member as resiliently urged by the spring.

9. A RF switch connector according to claim 1, wherein said pusher member includes a plunger resiliently retained on an upper portion of the spring to normally urge the switch lever upwardly, and a rod portion axially formed under the plunger and disposed within the spring to be reciprocatively moved within the inner cup.

10. A RF switch connector according to claim 1, wherein said fixed terminal and said switchable terminal are each made of electrically conductive materials, each said terminal integrally made respectively by mechanical processing.
